(19) United States
(12) Patent Application Publication
(10) Pub. No.: US 2007/0256293 A1
(43) Pub. Date: Nov. 8, 2007

(54) SEMICONDUCTOR ELECTRIC HEATING FILM AND METHOD OF FABRICATION THE SAME

(76) Inventor: Cheng Ping Lin, Taipei (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/609,192

(22) Filed: Dec. 11, 2006

(30) Foreign Application Priority Data
May 3, 2006 (TW) 095115801

(51) Int. Cl. H05B 3/00

(52) U.S. Cl. 29/611

(57) ABSTRACT

The invention discloses a fabrication method of semiconductor electric heating film at least comprising the steps of: preparing an elementary material from one of the metallic (Sn, V) chlorides or silicides, into which one of the compounds of Fe, Sb, In, Zn or Zr is further added as an anti-oxidation additive, above resultant is used as basic semiconductor electric heating film material having anti-oxidation property; uniformly mixing the aforesaid material, and taking a predetermined ratio of it to solve in a solvent; uniformly churning the resultant prepared in the above step, and adding a small amount of HF non-organic acid as an modifier so as to improve film's stability and causing oxidation or reduction between the solvent and the film material; and cleaning a substrate with supersonic wave and then washing it with pure water in order, after that setting the washed substrate in a furnace and heating the substrate with in-line heating process gradually, and as soon as the substrate's surface has reached the dual state temperature, depositing high temperature atomized and ionized particles of the finished coating material on the substrate's surface using a nozzle made of non-ferrous, acid and alkali proof substance so as form a layer of film.

### BACKGROUND OF THE INVENTION

1. Field of the invention

The present invention relates to semiconductor electric heating film and method of fabricating the same.

2. Description of the Prior Art

The conventional electric heating film utilizes heating coils to produce heat energy. But generally, the heating coil pertains to a high electric resistance material which is costly to consume, also a tedious winding process is required to perform in the factory.

The heating coils generate red hot heat energy by consuming heavy electricity and a large amount of ambient oxygen that leads to degrading the quality of indoor atmosphere. Moreover, the conventional heating unit formed of heating coils generate the red hot flame which is not suitable to be used as heating equipment in the oil fields located in the frigid zone.

As the remarkable progress in the same conductor technology has been accomplished in recent years, when heating equipment made of semiconductor material is compared with a traditional ohmic resistance heating apparatus, has superior features such as high temperature, no brilliant flame, electric energy saving, high heat generation efficacy, operation safety, and low production cost.

Among several patents related to the semiconductor electric heating film approved in China. One of them filed on Mar. 6, 2002 in China as CN No. 1,380,443A disclosing “Technique of Controlling Pasty Condition of the material for forming a Semiconductor Electric Heating Film”. The technical contents thereof are as follows:

In the conventional electric heat oxidation film fabrication process by setting a substrate of electric heat film in the furnace and injecting high temperature vaporized fluid film into the furnace, the uniformity of product can not be ensured due to failing to perform proper control of the substrate temperature and the efficacy in forming the film. Accordingly, the afore said cited invention provided an electric heat film coating technique which can solve the problem of non-uniformity of the fabricated electric heat film.

The essential technique disclosed by the cited invention is to timely transmit the substrate already set in the furnace to a preset control station, and send an instant control signal about forming efficiency from the control station.

The cited invention disclosed steps of fabrication as follows:

1. Transmitting the information about the thickness of film which has been formed on the substrate set in the furnace to the control station.

2. Transmitting the information about the coating pressure to the control station.

3. Outputting a signal from the control station to control the distance between the injection nozzle and the substrate.

4. Outputting a signal from the control station for controlling the moving speed of the substrate.

5. Outputting a signal from the control station for controlling injection of fluidal coating material.

6. Outputting simultaneously aforesaid various control signals from the control station.

Besides, a Taiwanese company, Ho Li Co. Ltd. Has disclosed “Electric Heating Film and Electrodes of the Same”, which was patented in Taiwan with application No. 90126,142 filed on Oct. 23, 2001. The essential contents thereof mentioned in said patent are as follows:

Prior to the application of this case, persons skilled in the art know that the principle of operational function of an electric heat film is mainly to apply a bias voltage between an upper and a lower rectangular electrodes of the same width so as to generate heat energy. But it is known that the density of the biased current has a lager value in the central region of the electrical heat film than in other portions. As a result, there will arise a demerit of overheating the central portion yet getting poor heating efficiency at the both edges thereof.

The second cited invention was made for rectifying above demerit by adjusting the width and disposing aspect of the film. This invention provided means “laying more than one electric heating film between more than one pair of electrodes, wherein the width of the paired electrodes is larger in the two sides than in the middle portion thereof” so as to adjust current density in the electric heating film as uniform as possible by reducing the resistance of two sides of the paired electrodes so that the problem of overheating in the middle portion of the film and poor heating efficiency at two sides thereof can be solved.

Meanwhile, the edge profile of connection between the paired electrodes and the film is arcuate or sinuous.

Furthermore, a “Method of Fabricating Semiconductor Electric Heating Film” which was patented in Taiwan and was filed on Apr. 26, 1993 with filing No. 82,103,268 disclosed the following technical contents:

The conventional ohmic heating element prior to this invention has inherent disadvantages such as high cost, consuming large electric power, easy to oxidate that leads to failure etc. Besides, the ceramic heater element (PTC) has the demerits of a large inrush current, high material cost, poor yield and high production cost. Accordingly, this invention aimed to provide a semiconductor electric heating film cable of elimination aforesaid demerits.

This invention includes following steps:

1. Material preparation: employing one of the metallic (Au, Ag, Sb, . . .) compounds, or organic compounds by mixing 1˜10% (weight ratio) of other compound (Sb, Fe, F, . . . ) as an additive;

2. Uniformly mixing material: uniformly mixing 20˜60% (weight ratio) of said compounds with one solvent selected from (water, methyl alcohol, hydrochloride acid, ethyl alcohol, ethylamine, . . . ).

3. Cleaning substrate: employing one of the high temperature withstanding and low expansion coefficient preformed elementary substance selected from (quartz, glass, ceramic, mica) to use as a substrate, and dry it with fire after being cleaned its surface with pure water; and

4. High temperature atomization: setting the substrate been treated in a furnace and activating its surface with high temperature, then injecting the atomized coating material into the furnace and depositing the ionized particles on the surface of the substrate thereby completing the formation of a semiconductor electric heating film.

For summarizing the invention, the keypoints of the fabrication process can be concluded as: mixing the additive in the metallic compound elementary coating material mixing with the solvent cleaning the substrate surface injecting the prepared atomized coating material into the high temperature furnace to form an electric heating film.

The above three prior inventions regarding fabrication of electric heating film have inherent disadvantages of high raw material cost, in lack of anti-oxidation ability, and in lack of precision in fabrication process unable to manufacture a semiconductor electric heating film of high temperature withstanding, energy saving, high heat generating efficiency, safety, and low production cost.

### SUMMARY OF THE INVENTION

The main object of the present invention is to provide a novel semiconductor electric heating film which is more effective and lower cost than the conventional ones, and method of fabricating the same.

To achieve the above object, an anti-oxidation additive is added to the main electric heating material so as to enhance anti-oxidation property of the semiconductor electric heating film.

Moreover, in an embodiment of the present invention, the semiconductor electric heating film is formed into multi-layered structure in which an anti-oxidation film is added so as to enhance the anti-oxidation property of the semiconductor electric heating film thereby greatly prolonging its lifespan.

In the present invention, during multi-layered film fabrication process, after mixing the main semiconductor electric heating film material with an additive and solvent, an certain amount of non-organic acid is added as a modifier so as to enhance the product stability which leads to a better production yield.

By doing so, the fabrication process of the film can be conducted stably, safely and efficiently to curtail production cost.

In the present invention, those expensive materials such as gold or silver compounds are never used as main fabrication material, and instead, rather low cost metallic compounds are selected so that the production cost is greatly lowered.

In an embodiment, the fabrication steps at least comprises:

Preparing an elementary material from one of the metallic (Sn, V) chlorides or silicides, into which one of the compounds of Fe, Sb, In, Zn or Zr is further added as an anti-oxidation additive, above resultant is used as basic semiconductor electric heating film material having anti-oxidation property;

uniformly mixing the aforesaid materials, and further taking a predetermined ratio of it to solve in a solvent;

uniformly churning the resultant material prepared in above step, and adding a small amount of HF non-organic acid as a modifier so as to improve film's stability and causing oxidation or reduction between the solvent and the film material; and

cleaning a substrate with supersonic wave and then washing it with pure water in order, afterwards setting the washed substrate in a furnace and heating the substrate with the in-line heating process gradually, and as soon as the substrate's surface has reached the dual state-temperature, depositing high temperature atomized and ionized particles of the finished coating material on the substrate's surface using a nozzle made of non-ferrous, acid and alkali proof substance so as to form a layer of film.

In the above embodiment, the solvent is one selected from water, methyl alcohol, ethyl alcohol, boric acid, hydrochloric acid, and sulfoacid.

In the above embodiment, the substrate is made of high temperature withstanding, electrically insulating with low expansion coefficient material such as enamel, quartz, glass and ceramic.

In the above embodiment, the atomization temperature applied to the film is 500˜1000° C. with time duration for 1˜10 min.

In the above embodiment, the thickness of film is 0.5˜5 μm.

### BRIEF DESCRIPTION OF THE DRAWINGS

The above and other objects, features and advantages of the present invention will be more apparent from the following detailed description taken in conjunction with the accompanying drawings, in which:

FIG. 1A and FIG. 1B are respectively a plan view and a sectional view of the prior semiconductor electric heating film structure disclosed by the applicant of the present invention;

FIG. 2A and FIG. 2B are respectively a plan view and a sectional view of the semiconductor electric heating film structure according to the present invention; and

FIG. 3 is a schematic view illustrating the fabrication system of the semiconductor electric heating film according to the present invention.

### DETAILED DESCRIPTION OF THE PREFERRED EMBODIMENTS

The novelty and other features of the present invention will be well understood by detailed description of the following preferred Embodiments.

### Embodiment 1

The present invention at least comprises the following steps: preparing the metallic chloride of Sn or V and a silicide as an elementary material, preferably in powdered state; mixing uniformly 0.011% (weight ratio) of the material selected from one of the powdered compounds of Fe, Sb, or In, into the elementary material during the preparing process serving as an anti-oxidation additive; mixing uniformly the above materials and mixing the specified ratio of above materials with a solvent of preferably 10˜30% (weight ratio) of the prepared materials;

after the materials are homogeneously churned, adding a small amount of non-organic acid selected one from nitric acid, sulphuric acid and hydrochloric acid so as to intensify the chemical affinity of the elementary material with the solvent and facilitate oxidation and reduction thereof; and

afterwards, cleaning the substrate with supersonic wave and pure water in order and setting it in a furnace and heating with high temperature by in-line process slowly, as soon as its surface has reached the dual state temperature, depositing a layer of high temperature particles of atomized ions on the substrate's surface by injection of the fluid material from a nozzle made of a non-ferrous, acid-proof and alkali-proof substance.

In the above process, water, methyl alcohol, ethyl alcohol, boric acid, hydrochloric acid and sulfuric acid are used as solvent.

In the above process, the substrate is made of high temperature withstanding electrically insulating and low expansion coefficient material such as enamel, quartz, glass and ceramic. The thickness thereof depends on the actual requirement.

In the above process, the applied temperature for automation in the furnace is 500˜1000° C., for 110 min.

In the above process, the deposition thickness of atomized film on the substrate is 0.5˜5 μm.

According to above process, a high quality, highly effective and low cost semiconductor electric heating film can be obtained.

### Embodiment 2

In this embodiment, the semiconductor electric heating film is made multi-layered but integrally combined as a single layered state. Among those layers, the uppermost one is an electric heating film for conducting and dissipating heat generated from electrical current and serving as an anti-oxidation film as well. With this structure, the semiconductor electric heating film is more anti-aging and durable. The fabrication method thereof will be described hereinbelow.

(1) Semiconductor Electric Heating Film

A. Elementary material: chloride of Sn, V or silicide (e.g. SnCl₂·5FLO), with dosage 40˜60% (weight ratio) of total film construction substance.

B. Additive: SbCl₃: 0.5˜1.5% (weight ratio), InCl₃: 0.3˜0.5% (weight ratio), AgNO₃: 0.3˜0.5% (weight ratio).

C. Solvent: \textcircled{1} methyl alcohol \textcircled{2} ethyl alcohol \textcircled{3} isopropanol, mixing in 4˜6:4˜6:1˜3 of volume ratio, the volume of the solvent is 20˜40% that of the total semiconductor electric heating film material.

D. Modifier: The modifier is used to enhance stability of the film product, an organic or non-organic HF acid is a preferable selection with the dosage 0.2˜0.8 (weight %) of total semiconductor electric heating film.

E. Fabrication procedure (using SnCl₂ for the elementary material):churning the mixture of aforesaid elementary material, additive, solvent, and modifier, after that, heating the resultant and coating the surface of the substrate by injection, the chemical reaction will be as follows (R is the “radical” of Solvent)

SnCl₄+5H₂O+4ROH→Sn(OR)₄+4HCl+5H₂O (a)

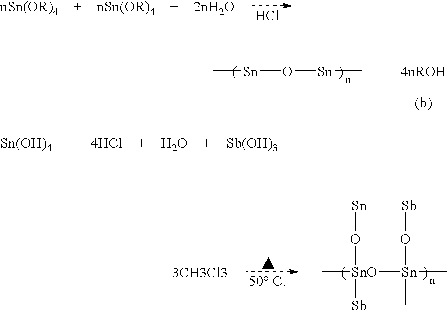

In the above chemical reaction, (a) is an oxidation reaction, (b) is a reduction reaction. Addition of a modifier serves to adjust the number of N in the crystal {Sn—O—Sn} and the structure after crystallization so as to contribute to enhancing stability of the semiconductor electric heating film product.

Meanwhile, according to a test conducted by the applicant, the thermal stress and electrical conductivity of the heating film can be influenced by different additives added.

(2) Anti-Oxidation Film

A. Elementary material: chloride of Sn, V or silicide (as Sncl₂·5H₂O) with dosage 40˜60 weight % preferably of total construction material of anti-oxidation film, the elementary material serves to integrally combine the anti-oxidation film and the semiconductor electric heating film.

B. Additive: The amount used are ZrCl₂ 6˜10 weight %, ZnCl₂ 10˜15 weight %, SbCl₃: 5˜10 weight %, AgNO₃: 0.5˜1 weight %. Except able to adjust thermal stress and electrical conductivity of the anti-oxidation film, the additive aids oxidation function of the anti-oxidation film. For example, the mixture of Zn or Zr chloride with the elementary material become a poor conducting material after reaction at a high temperature, and refusal to react with oxygen in the air.

C. Solvent: mixing \textcircled{1} methyl alcohol and \textcircled{2} ethyl alcohol with the volume ratio of 2˜4 :2˜3 plus 0.5˜1.3 weight ratio of boric acid to form a resultant solvent. Addition of boric acid serves to reduce thermal stress and inhibit growth of anti-oxidation film crystal so as to assist incorporation of the anti-oxidation film with the semiconductor electric heating film.

D. Fabrication procedure: After mixing and heating the aforesaid elementary material, additive, and solvent, the resultant solution is injected in the form of atomized particles on the surface of the substrate covered with the electric heating film using the aforesaid injection nozzle. By so, the electric heating film is then covered by the atomized particles thereby completing fabrication of multi-layered semiconductor electric heating film.

### Embodiment 3

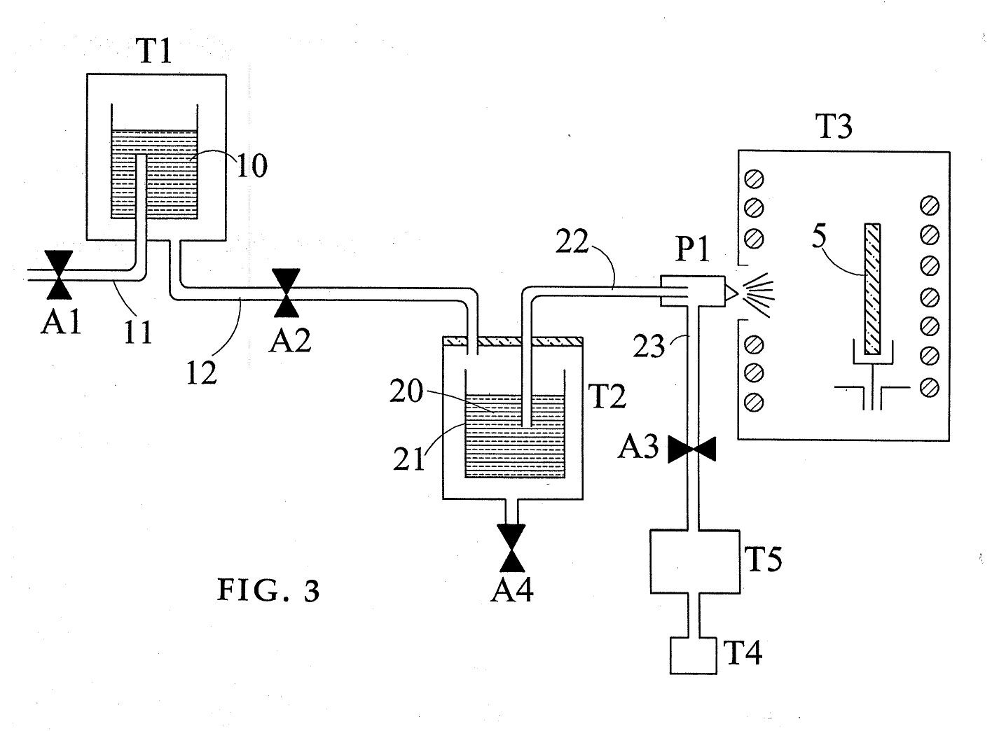

As shown in FIG. 3, in view of the fact that the resultant solution containing a variety of alcoholic solvent exhibit various vapor pressures when volatiling that affects the material stability. In this embodiment, a mixed solvent 10 and a mixed material 20 is respectively put in a sealed container T₁ without an electromagnetic valve A₁ for controlling input air flow and a sealed material chamber T₂. The sealed container T₁ is connected to an air input tube 11 to introduce air into the mixed solvent 10, and the sealed container T₁ is further connected to a vapor outlet tube 12 without an electromagnetic valve A₂ so as to communicate with the sealed material chamber T₂ and a mixed material container 21 installed in the material chamber T₂.

The solvent 10 contained in the sealed container T₁ produces solvent vapor when being heated in the air, the vapor migrates into the mixed material 20 stored in the material chamber T₂ so as to balance its pressure with that of the material chamber T₂ and inhibit volatilization of the mixed material 20 therein thereby properly controlling the concentration of the solution of the mixed material. The material chamber T₂ is provided with a pressure relief valve A₄, and a conducting tube 22 is extended from the material container 21. An injection nozzle P₁ made of non-metallic substance is affixed to the front end of the conducting tube 22 and is inserted into a high temperature furnace T₃ so as to inject automized structural material of the semiconductor electric heating film on a substrate S. The injection nozzle P₁ is connected to an air conducting tube 23 to introduce air from an air compressor T₄ and an air storage tank T₅ with an electromagnetic valve A₃ to control the air flow rat therefrom.

### Embodiment 4

The embodiment explains the principle how the semiconductor electric heating film is adjusted to spread properly so as to avoid damage to the substrate arising from non-uniform heating.

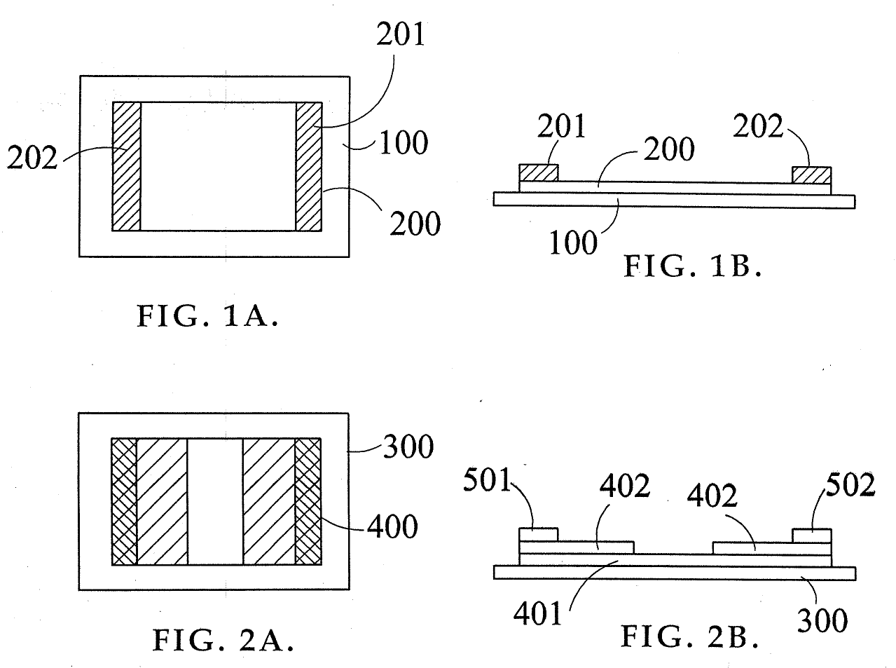

Referring to FIG. 1A and FIG. 1B, as described above, the present invention uses non-organic planar and tubular substances such as quartz, glass, ceramic mica, and enamel as its substrate material. Each of the above substances has its inherent physical property. Moreover, as electrodes 201 and 202 are equipped at the two sides of the electric heating film 200 covering on the surface of the substrate 100, it causes a slow heat exchange in the middle portion of the heater body. BY so, the excessive concentration of heat in the middle portion thereof may result in exfoliation of the electric heating film 200 at the middle portion of the substrate 100 and cause fatal damage thereof. Besides, poor heating efficiency and non-uniform heating effect will greatly degrade the heating quality which fails to satisfy the heated object.

In the present embodiment, as shown in FIG. 2A and FIG. 2B, the electric heating film element 400 (401+402) covered on the substrate 300 is formed in the manner that it is thicker at right and left sides but thinner at the middle portion. To attain such structural feature, two layers of electric heating film elements 401 and 402 are covered on the substrate 300, of which the second layer of film 402 is formed off the middle portion of the substrate 300, and two electrodes 501 and 502 are formed at two sides of the upper (second) layer 402. With this structure the heat generation of the electric heating film 400 becomes very uniform so that the phenomenon of excessive concentration of heat at the middle portion of the substrate 300 can be prevented.

While the invention has bee described in terms of what are presently considered to be the most practical and preferred embodiments, it is to be understood that the invention need not be limited to the disclosed embodiments. On the contrary, it is intended to cover various modifications and similar arrangement included within the spirit and scope of the appended claims which are to be accorded with the broadest interpretation so as to encompass all such modifications and similar structures.

What is claimed is:

1. A method of fabricating semiconductor electric heating film comprising following steps:
preparing an elementary material using chlorides of Sn, V, and silicides, and adding an additive during preparation;
mixing uniformly said component materials, and further mixing with a predetermined ratio of solvent;
adding a small amount of non-organic acid as an modifier into said uniformly churned mixture obtained in above step so as to enhance stability of said electric heating film and actuate oxidation reaction and reduction reaction between said solvent and said elementary material; and
after being cleaned, setting a substrate into a furnace to heat gradually until its surface reaching the dual-state temperature, afterwards, depositing high temperature atomized and ionized particles of said material on the surface of said substrate using a nozzle made of non-ferrous, acid and alkali proof substance;
wherein, in preparing said elementary material, one of the compounds of Fe, Sb, In, Zn and Zr is added as an anti-oxidation additive so as to make aforesaid material into a basic material of said semiconductor electric heating film having an anti-oxidation property.

2. The fabrication method as in claim 1, wherein the amount of said anti-oxidation additive is 0.01˜1 weight % of said elementary material.

3. The fabrication method as in claim 1, wherein said solvent is one selected from water, methyl alcohol, ethyl alcohol, boric acid, hydrochlonic acid, and sulfoacid.

4. The fabrication method as in claim 1, wherein said substrate is made of a high temperature withstanding, electrically insulating and low expansion coefficient material selected from enamel, quartz, glass and ceramic.

5. The fabrication method as in claim 1, wherein said atomized particle deposition process is performed at temperature 500˜1000° C. for 1˜10 min.

6. The fabrication method as in claim 1, wherein the thickness of said atomized particle deposition is 0.5˜5 μm.

7. A method of fabricating semiconductor electric heating film by covering the surface of a substrate with a plurality of electric heating film layers incorporated integrally to form into a single layered state; wherein the uppermost layer of said multi layers is able to conduct and dissipate heat produced in the lowest by electrical current, and is an anti-oxidation film with anti-oxidation ability as well.

8. The fabrication method as in claim 7, wherein the elementary material forming said electric heating film is one of chlorides of Sn, V, and silicides, the dosage is 40˜60 weight % of said total electric heating film.

9. The fabrication method as in claim 7, wherein additive for said electric heating film is the mixture of SbCl₃, InCl₂, and AgNO₃.

10. The fabrication method as in claim 7, wherein a solvent for said electric heating film is the mixture of methyl alcohol, ethyle alcohol, and isopropanol mixing in 4˜6: 4˜6:1˜3 of volume ratio, the volume of said solvent is 20˜40% that of the total semiconductor electric heating film.

11. The fabrication method as in claim 7, wherein an adjuvant for said electric heating film is a non-organic HF acid with the dosage 0.2˜0.8 weight % of said total semiconductor electric heating film.

12. The fabrication method as in claim 7, wherein when SnCl₄·5H₂O is selected as the elementary material, said elementary material, said additive, said solvent and said adjuvant are heated after being mixed and churned to be covered on said substrate by injection, the oxidation and reduction are performed according to the reaction:
SnCl₄+5H₂O+4ROH→Sn(OR)₄+4HCl+5H₂O (a)

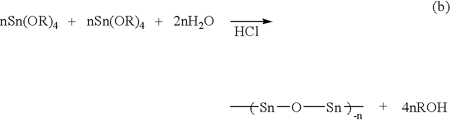

13. The fabrication method as in claim 7, wherein the elementary material of said anti-oxidation electric heating film is one of chlorides of Sn, V, or a silicide with the dosage 20˜30 weight % of the total construction material of said electric heating film.

14. The fabrication method as in claim 13, wherein the additives for said anti-oxidation film is mixture of ZrCl₂, SbCl₃, and AgNO₃.

15. The fabrication method as in claim 13, wherein the solvent for said anti-oxidation film is methyl alcohol and ethyl alcohol mixed with boric axid.

16. A method of fabricating semiconductor electric heating film wherein a substrate covered by a single layered or multi-layered electric heating film is constructed in a manner thinner in the middle portion and thicker around the outer edges.

17. The fabrication method as in claim 16, wherein said electric heating film formed around the outer edges of said substrate is a multi-layered film.
